(19) United States
(12) Patent Application Publication
(10) Pub. No.: US 2012/0236787 A1
(43) Pub. Date: Sep. 20, 2012

(54) METHOD FOR ENABLING A WIRLESS COMMUNICATION DEVICE, CONNECTED TO A FIRST DOMAIN OF A NETWORK, TO ACCESS A SERVICE IN A SECOND DOMAIN, WIRELESS COMMUNICATION DEVICE AND COMMUNICATION SYSTEM

(75) Inventor: Apostolis K. Salkintzis, Athens (GR)

(73) Assignee: MOTOROLA MOBILITY, INC., Libertyville, IL (US)

(21) Appl. No.: 13/049,575

(22) Filed: Mar. 16, 2011

(51) Int. Cl. H04W 4/00

(52) U.S. Cl. 370/328

(57) ABSTRACT

A method for enabling a wireless communication device (122), connected to a first domain (106) of a wireless communication network (101), to access a service in a second domain (114) is disclosed. The method comprises receiving (404) at the wireless communication device (122) a service message from the first domain (106) indicating that a service in the second domain is available and including connectivity information for indicating how a connection to the second domain can be established and service access information for indicating how the service can be accessed after establishing a connection to the second domain. In response to a user of the wireless communication device requesting (408) access to the service in the second domain, establishing (410) a connection to the second domain using the received connectivity information, and accessing (412) the service in the second domain using the received service access information. A device and system are also disclosed and claimed.

### FIELD OF THE DISCLOSURE

This disclosure relates to a method for enabling a wireless communication device, connected to a first domain of a wireless communication network, to access a service in a second domain, a wireless communication device and a communication system.

### BACKGROUND OF THE DISCLOSURE

With the development and deployment of new wireless services and networks, such as Local IP Access (LIPA) services, and Wi-Fi services, network operators can offer an increasing number of wireless services to users along with the traditional wireless services, such voice services over GSM, LTE or UMTS wireless communication systems.

For example, LIPA services enable IP-enabled wireless communication devices to access a user's residential or home-based local network (e.g. so that IP traffic generated via the Home Node B (HNB) is routed directly to the users local network) as well as the broader Internet directly using the air interface of a femtocell. Using LIPA facilitates the offloading of traffic from the operator's core network which is ultimately destined for the Internet and also provides access to the devices connected in the residential or home-based local network (e.g. desktop/laptop computers, printers, Internet-enabled gaming systems, media centres). The Third Generation Partnership Project (3GPP) is currently looking at solutions for deploying LIPA in enterprises or enterprise environments, where enterprises may include corporations, small businesses, non-profit institutions, government bodies, academic campus', airports, shopping centres or similar enterprise environments.

However, in order for users to access different wireless services via their wireless communication devices, the user needs certain information, such as when is a wireless service available to the user, and how can the user access the wireless service.

For example, in the case when a network operator wants to make data services available to a roaming user via the network operator's data network, in order for the roaming user to access the data services, the roaming user's wireless communication device typically requires the following information:

an Access Point Name (APN) through which the data services of the network operator are accessible;

credentials for connecting to this APN (such as a username/password);

an HTTP URL to access a local portal after connection to the APN; and

a suitable trigger to initiate the connection to the APN and to access the local portal after the user requests to access the data service.

Static provisioning of this information is not practical in view of the amount of information that would have to be pre-stored in the user's device in order to enable the user to access all the different services that may be available to the user as the user roams in many different communication networks.

Dynamic provisioning of this information is feasible but would require significant network overhead in terms of the signalling required in order to provide this information dynamically to the user's device. In addition, the operator's provisioning platform may require upgrading in order to support dynamic provisioning of this information in a large range of different wireless communication devices. This upgrade would have to support additional provisioning elements and functions (e.g. additional OMA Device Management (DM) objects) which are specifically required to support the dynamic provisioning of this type of information.

In another example, for LIPA services, the user's device would typically need to know when LIPA services are available, over which APN can the LIPA services be accessed, what credentials (user name/password) are to be used, what is the URL for the LIPA portal (if there is a portal). Such information does not exist currently so that the user's device does not know when LIPA can be used, what APN must be activated, what credentials are to be used and what is the URL of the LIPA portal (if there is a portal). Provisioning of this type of information for all different LIPA scenarios (both in roaming and non-roaming cases) is also deemed impractical.

### BRIEF DESCRIPTION OF THE DRAWINGS

A method for enabling a wireless communication device, connected to a first domain of a wireless communication network, to access a service in a second domain, a wireless communication device and a communication system, in accordance with the disclosure will now be described, by way of example only, with reference to the accompanying drawings in which:

FIG. 1 is a block schematic diagram of a communication system in accordance with an example embodiment of the present disclosure;

FIG. 2 is a block schematic diagram of a wireless communication device in accordance with an example embodiment of the present disclosure;

FIG. 3 is a flow diagram showing an example method in accordance with an embodiment of the disclosure for enabling a wireless communication device, connected to a first domain of a wireless communication network, to access a service in a second domain; and

FIGS. 4-7 each show a display of a wireless communication device with example messages that may be displayed to a user during the method of enabling a wireless communication device to access a service in accordance with an embodiment of the disclosure.

### DETAILED DESCRIPTION OF THE DRAWINGS

The term service as used herein is intended to cover services for the end user of a wireless communication device (e.g. originated or terminated at the wireless communication device) and includes circuit switched (CS) services such as voice calls, and packet switched (PS) services such as Voice over IP (VoIP) calls, video, audio or other multimedia sessions, file delivery services, bulletin board and broadcast notification services like news feed, web-surfing, network gaming, database access, email, SMS or similar services which provide the capability for information transfer.

A wireless communication device for use with the communication system and method in accordance with the disclosure may be a portable or handheld or mobile telephone, a Personal Digital Assistant (PDA), a portable computer, portable television and/or similar mobile device or other similar communication device. In the following description, the communication device will be referred to generally as a UE for illustrative purposes and it is not intended to limit the disclosure to any particular type of communication device.

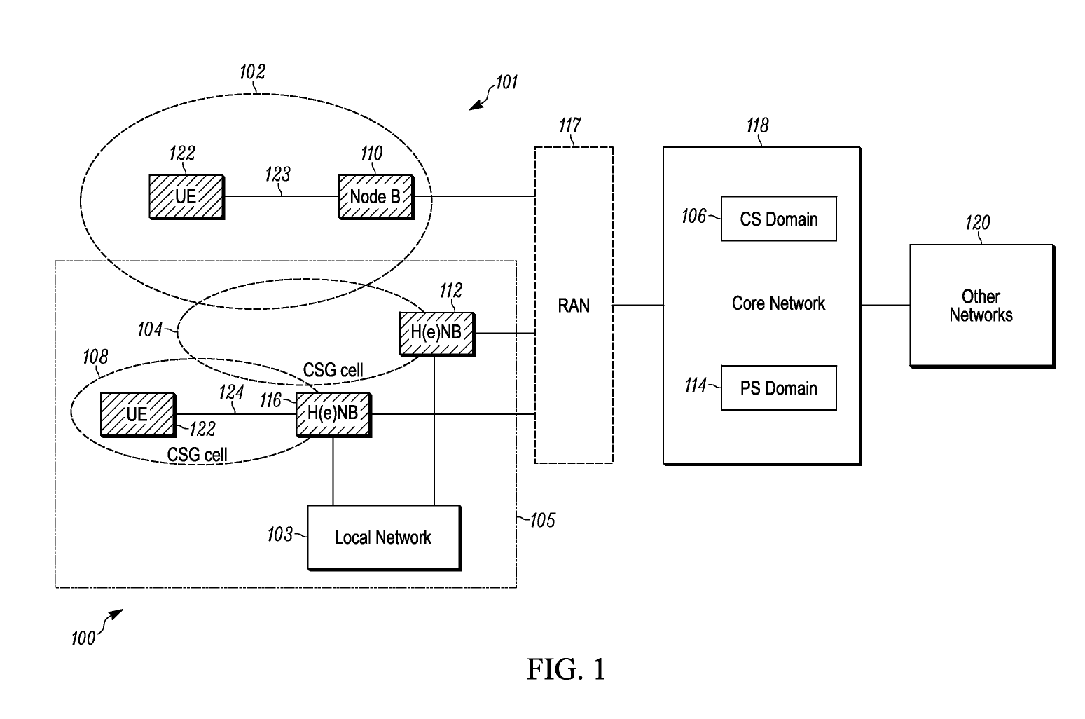

Referring now to FIG. 1, a communication system 100 in accordance with an example of an embodiment of the disclosure comprises a UMTS network 101. The UMTS network includes a plurality of coverage areas or cells served by base stations 110 (in UMTS referred to as Node Bs (NBs)) and plurality of closed subscriber group (CSG) or private cells 104, 108, with each private cell being served by a private base station or femtocell 112, 116. Only one coverage area 102 (also known as a macro cell) and Node B 110 are shown in FIG. 1 for simplicity. The Node Bs 110 and private base stations 112, 116 are communicatively coupled to a core network 118 via at least one RAN identified by the dotted line box 117 in FIG. 1 as is well known in the art.

A UE 122 may communicate via a radio communication link 123 with a Node B 110 of the cell or coverage area 102 within which the UE 110 is situated or located.

A UE 122 may communicate with the private base station 116 via a radio communication link 124 when the UE 122 is in the private cell 108 served by the private base station 116. The private base stations 112, 116 incorporate the functionality of a typical base station and some network functionality to allow a simpler, self contained implementation. The private base stations 112, 116 may be part of an enterprise environment (represented by dotted line box 105) which support LIPA. Thus, a UE may access a local network 103 of the enterprise environment via the private base stations 112, 116. The private base stations may alternatively be part of a residential environment. In enterprise deployment, the coverage area is larger than a residential deployment and so a plurality of private base stations or femtocells (HeNBs or HNBs) are required to provide connectivity to the local network in the enterprise.

The enterprise environment 105 may be, for example, for an airport, or a shopping centre or university campus as described in the introduction. A network operator may deploy several enterprise environments to cover several different enterprises.

In the following to simplify the description, the base station 110 will be referred to as NB 110, the private cells 104, 108 are referred to as CSG cells 104, 108 and the private base stations 112, 116 are referred to as H(e)NBs. It will however be appreciated that the use of this language is not intending to limit the scope of the disclosure

Other parts of the RAN(s), such as Radio Network Controllers (RNC) for serving the macro cells, are not shown in FIG. 1 for simplicity.

The core network 118 is communicatively coupled to one or more networks 120, such as a packet data network, the Internet, a CS network, an IP Multimedia Subsystem (IMS) network, a local IP network, and manages the RAN(s) 117 in order to provide services to or from a UE. The services may include IMS services from an IMS network or PS services from a packet data network or CS services from a CS network. The core network 118 is divided into a plurality of domains including a CS domain 106, and a PS domain 114 and includes network elements such as Mobile Switching Centres (MSCs), a Home Location Register (HLR), visitor Location Registers (VLR), a Serving GPRS Support Node (SGSN) and a Gateway GPRS Support Nodes (GGSN) or Packet Data Network Gateway (PGW) as is well known in the art and which are not shown in FIG. 1 for simplicity. In a UMTS communication system, a UMTS CS domain includes the UMTS RAN (known as UTRAN) and core network components that provide CS services and a UMTS PS domain includes the UTRAN and core network components that provide PS services.

The UE 122 may therefore be connected to one of the networks 120, 103 by means of the CS 106 or PS 114 domain so as to access a service(s). For example, the CS 106 or PS 114 domain may authenticate and authorize the UE 122 to access one of the networks 120 (for example via an attach procedure) and the PS 114 domain may additionally provide packet relaying functionality to enable the UE 122 to establish connectivity with one of the networks 120, 103. The relaying functionality is required when the UE 122 establishes IP connectivity with a network 120 via the PS domain. For CS services, once the UE is attached to the CS network, the UE is connected to the CS network and can access services. The PS 114 domain is not required to provide packet relaying functionality when the UE 122 establishes connectivity with local network 103 (only the H(e)NB performs packet relaying in this case).

Thus, when the UE 122 establishes a connection or is connected to an network, the UE 122 is first attached (e.g. authenticated and authorised) to the PS domain 114 or CS domain 106 of the network and then a communication link or connection is set up between the UE and the network via the PS domain or CS domain so that the UE can communicate with the network and access a service available through this network.

The number and types of networks available to a UE is determined by what networks are deployed in an area in which the UE is located. If the UE is in an area covered by the user's home network, the available networks will depend on the networks deployed by the user's operator. If the UE is roaming and so in an area covered by another operator, the available networks will depend on those deployed by the other operator. When roaming, the UE may be able to access local networks (e.g. LIPA networks, local IP networks) deployed by the visited operator and IP networks deployed by the user's home operator. It is not intended to limit the disclosure to a particular type of network, such as the UMTS network shown in FIG. 1, or combination of networks or domains. It will be appreciated that the present invention may apply to different wireless communication networks or systems and their combinations, such as GSM, UMTS, wireless LAN (WLAN), Worldwide interoperability for Microwave Access (Wi-MAX), Wi-Fi, Long Term Evolution (LTE), IP Multimedia Subsystem (IMS) systems, LIPA networks, local IP networks.

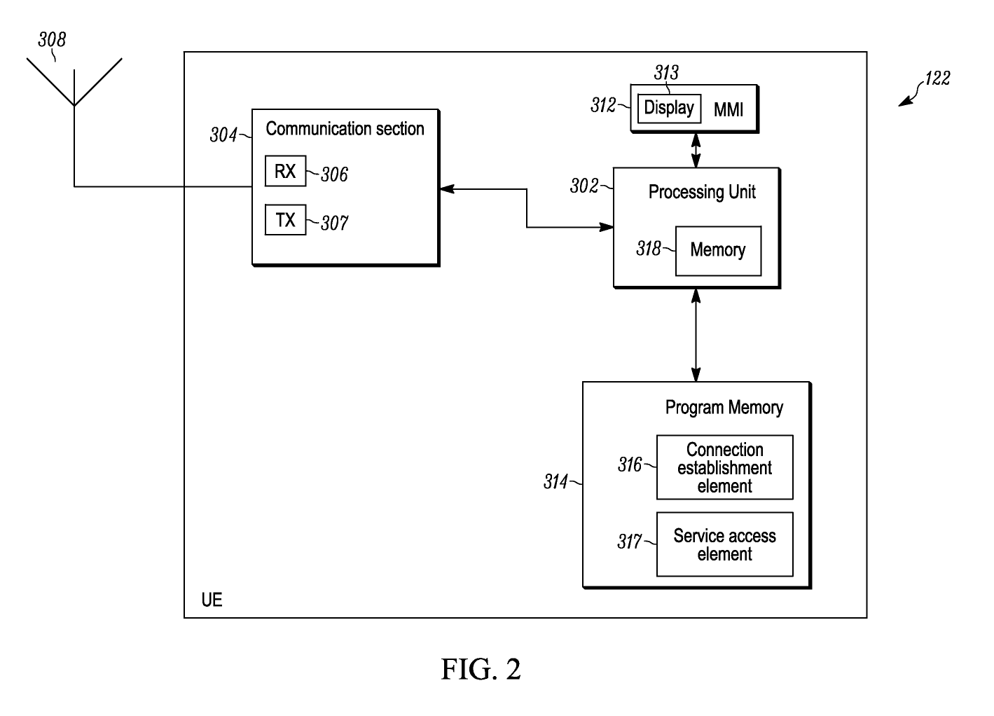

FIG. 2 is a block diagram of a wireless communication device, such as the UE 122 shown in FIG. 1, in accordance with an embodiment of the disclosure. In the following description, reference is made to a communication device comprising a UE. As will be apparent to a skilled person, FIG. 2 shows only the main functional components of an exemplary UE 122 that are necessary for an understanding of the invention.

The UE 122 comprises a processing unit 302 for carrying out operational processing for the UE 122. The UE 122 also has a communication section 304 for providing wireless communication via a radio communication link with a serving base station such as Node B 110 of FIG. 1. The communication section 304 typically includes an antenna 308, a receiver 306, a transmitter 307, modulation/demodulation section (not shown), and a coding/decoding section (not shown), for example, as will be known to a skilled person and thus will not be described further herein. The communication section 304 is coupled to the processing unit 302.

The UE 122 also has a user interface or Man Machine Interface MMI 312, including elements such as a key pad, microphone, speaker, display 313, for providing an interface between the UE and the user of the UE. The MMI 312 is also coupled to the processing unit 302.

The processing unit 302 may be a single processor or may comprise two or more processors carrying out all processing required for the operation of the UE 122. The number of processors and the allocation of processing functions to the processing unit is a matter of design choice for a skilled person. The UE 122 also has a program memory 314 in which is stored programs containing processor instructions for operation of the UE 122. The programs may contain a number of different program elements or sub-routines containing processor instructions for a variety of different tasks, for example, for: communicating with the user via the MMI 312; and processing signalling messages (e.g. paging signals) received from the core network 118. Specific program elements stored in program memory 314 include a connection establishment element 316 for establishing a connection with a domain and service access element 317. The operation of the connection establishment element 316 and service access element 317 will be described in more detail below.

The UE 122 further comprises a memory 318 for storing information. The memory 318 is shown in FIG. 2 as being part of the processing unit 302 but may instead be separate to the processing unit 302.

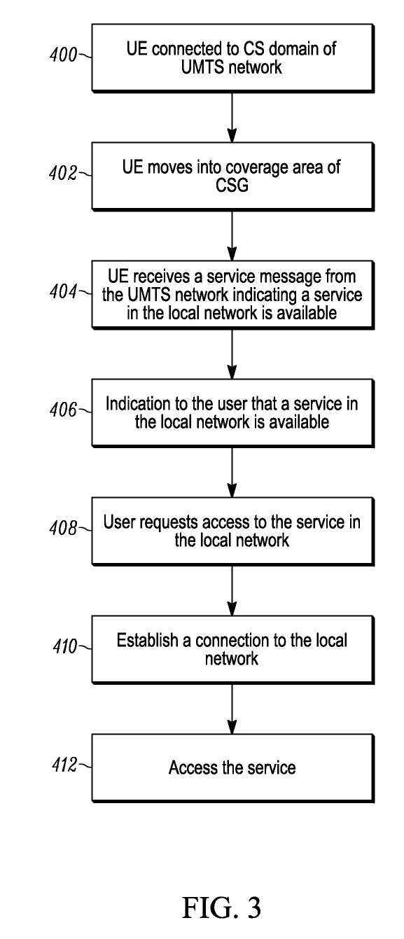

An example of a method of enabling a UE, connected to a first domain of a wireless communication network, to access a service in a second domain in accordance with the disclosure will now be explained in more detail with further reference to FIG. 3.

In broad terms, a communication system in accordance with the disclosure comprises a first domain of a wireless communication network for providing first services to a user and a second domain for providing second services to a user. The first and second domains may be part of the same wireless communication network or the first and second domains may be domains of different wireless communication networks. In the latter case, for example, the first domain may be a domain (e.g. PS or CS domain) of a first wireless communication network and the second domain may be a domain (e.g. PS or CS domain) of a second wireless communication network or a second wireless communication network itself For example, the second domain may be any IP network, including a WiFi network, a Bluetooth network, an enterprise/home network accessible with LIPA access, or a packet data network accessible via the PS domain of a wireless communication system (e.g. IMS).

With reference to the example arrangements shown in FIG. 1, in the example case where the first and second domains are part of the same network, the first domain may be the CS domain 106 and the second domain may be the PS domain 114 such that a UE may be connected to the CS domain 106 and may receive a message over the CS domain 106 indicating that a connection to an IP network (also known as a Packet Data Network (PDN)—see 3GPP TS 23.060, the disclosure of which is incorporated herein by reference) via the PS domain 114 is available. In the example case where the first and second domains are part of different networks, the first domain may be a PS domain 114 or the CS domain 106 of the core network 118 and the second domain may be the local network 103 of the enterprise environment 105 accessible with LIPA access (see 3GPP TS 23.401 and 3GPP TR 23.829, the disclosure of which is incorporated herein by reference) or an IMS network accessible via the PS domain of a wireless communication network. Other examples may include the second domain being a public WiFi hotspot or a residential WiFi network or a device in a Bluetooth network or a PDN accessible via the PS domain of the currently registered wireless communication network (e.g. a PDN used by a visited wireless communication network to provide IP services to roamers).

In the following, a method in accordance with the disclosure will be described with reference to FIG. 1 and a UE 122 initially being connected to the UMTS network 101 via the CS domain 106 of the UMTS core network 118. It will be appreciated that this is for illustrative purposes only and it is not intended to limit the scope of the method to the particular arrangement shown in FIG. 1 and described below. For example, the UE may be connected to the PS 114 for the provision of PS services.

At block 400, a UE 122 is connected to the CS domain 106 of the UMTS network 101 for the provision of CS services. For example, the UE 122 is located in coverage area 102 and is connected to the CS domain 106 via Node B 110. At block 402, the UE 122 moves into an area covered by the CSG cell 104 served by H(e)NB 112. The UMTS network (e.g. the core network 118 or the home network of UE 122) determines that the UE 122 is now located in the coverage area of CSG cell 104 (e.g. by inspecting the location area update messages sent by the UE 122) and sends a service message via the CS domain 106 to the UE 122. The UE 122 receives at the receiver 306 the service message from the CS domain 106 of the UMTS network 101 at block 404 and the service message indicates that connection to a service in the local network 103 is available. The service message may, for example, be a SMS message received from the CS domain 106. When the UE is connected to the PS and CS domain the service message may be a SMS message received from the CS domain or a MMS message received from the PS domain. The service message may additionally or alternatively be broadcast or multicast to the UE 122, for example, by one or more Node Bs. For example, the service message may be broadcast via the SMS-Cell Broadcast (SMS-CB) service.

In an example arrangement, the UE 122 may itself detect the availability of the local network 103. In this case, the service message acts as a prompt for the UE 122 to establish a connection to the local network 103 via the domain of the local network to access a service available in the local network 103.

In an example arrangement, the service message further includes connectivity information for indicating how a connection to the local network can be established and service access information for indicating how the service can be accessed after establishing a connection to the local network.

The connectivity information may be transferred to the UE 122 by SMS, MMS, email, HTTP or similar transport means.

The service message includes connectivity information for the local network 103 so that the UE can connect to the local network 103 and service access information so that the UE can access a particular service(s) in the local network 103 after it is connected to the local network 103. The connectivity information may include connectivity parameters. The connectivity parameters are parameters which enable the UE to connect to a specific IP network or device so that services may be accessed via this connection. The connectivity information may also include credentials, such as user name and passwords, to access services via the local network.

The connectivity parameters provide information which indicates to the UE a type of connection that is required to connect to a network via the network's domain. For example, the type of connection may be a dialup connection in which case the connectivity parameters may include a telephone number and logon credentials, or a WiFi network connection in which case the connectivity parameters may include a WiFi network identifier (also known as SSID), security methods (e.g. EAP-TTLS), or a connection that provides access to a PDN via the PS domain in which case the connectivity parameters may include a specific APN and information to establish a new PDP context/PDN connection to the specific APN (such as the type of requested IP address, logon credentials), or a LIPA connection in which case the connectivity parameters may include a specific APN and information to establish a new PDP context/PDN connection to the specific APN as above, or a Bluetooth connection in which case the connectivity parameters may include the name of the device to connect to and pairing information.

The service access information provides information to indicate how the service may be accessed after a connection is established. For example, the service access information may include network path information, such as location information including a transport scheme (e.g. HTTP, FTP, etc.), to identify a resource.

The connectivity information and service access information may be embedded in a service message by means of a suitably formatted Uniform Resource Locator (URL), called a ‘decorated’ URL.

In an example arrangement, the service message includes a ‘decorated’ URL. A ‘decorated’ URL is a standard URL (e.g. a URL conforming to the known format specified in the document RFC 1738) which embeds service access information, such as network path information (e.g. transport and location information) and also connectivity information.

The URL structure as per RFC 1738 is:

<scheme>//<user>:<password>@<host>:<port>/<url-path>

An example of a ‘decorated’ URL included in a service message that is provided by the UMTS network to the UE for connection to a local network, such as the local network 103 is:

http://apn?roamers.localservices?user:12345@video.example.com

with APN identity=roamers.localservices, user name=user, password=12345 (proxy and port could also be included if necessary) and stripped URL=http://video.localservices.com

It is noted that the above ‘decorated’ URL is different from a normal URL that is widely used in the internet today because the ‘decorated’ URL not only provides service access information such as network path information including a location of a specific resource (e.g. web portal or application server), but it also provides connectivity parameters which indicate the type of connectivity that should be established before this resource can be accessed.

For example, the ‘decorated’ URL shown above, indicates to a UE that access to a service or video portal, ‘vidoe.example.com’, is feasible by means of the HTTP protocol but only after connectivity to a packet data network with ‘APN=roamers.localservices’ is established with certain credentials (e.g. username, password). When the UE receives this ‘decorated’ URL, first it uses the connectivity parameters in the ‘decorated’ URL to establish the appropriate connection e.g. to the specific APN and then the UE can attempt to access the specified resource. The connectivity parameters included in the ‘decorated’ URL instruct the UE to establish a specific connection e.g. a dialup connection, a WiFi network connection, a packet data network connection with a specific APN, a LIPA connection, a Bluetooth connection, etc.

In an example arrangement, in response to receiving the service message, the UE 122, by means of the processing unit 302, indicates to the user of the UE that connection to a service in the local network 103 is available, block 406.

After the UE 122 receives the service message, the UE 122 may for example display a message on the display 313 of the UE 122 which message indicates that a connection to a service in the local network 103 is available with the message including a link associated with the received connectivity information and service access information. Other means of indicating that a connection to the local network 103 is available may additionally or alternatively be used. Such as an audible alert or the connectivity information (e.g. URL) itself may be displayed.

The message displayed may be part of the service message received (e.g. the link may be the ‘decorated’ URL) or may be pre-stored in memory 318. In the case when the message is pre-stored, in response to receiving the service message, the processing unit 302 of the UE 122 may retrieve the pre-stored message and provide it to the display 313 for display.

If the user wants to access the service in the local network 103, the user can request access to the service in the local network 103, block 408. For example, the user may select the link displayed in the message by clicking on the link or provide an audio input. This is detected by the processing unit 302 via the MMI 312.

In response to the user requesting access, the UE 122 is arranged to establish a connection to the local network 103 using the received connectivity information, block 410. This may be performed by the processing unit 302 under the control of the connection establishment element 316.

In an example arrangement, when the user selects the local network 103 by selecting a link in the message displayed on the UE 122, the connectivity information and the service access information associated with the link is retrieved. For example, the ‘decorated’ URL associated with the link is retrieved.

The UE 122 may then parse the retrieved information to obtain the connectivity parameters and network path information for use in establishing a connection to the local network 103 via local network domain.

The steps taken to establish a connection to the local domain 103 are well known. For example, see the LIPA procedures specified in 3GPP TS 23.401, the disclosure of which is incorporated herein by reference. Once a connection has been established with the local network 103, the UE 122 accesses the service in the local network 103 using the received service information under control of the service access element 317, step 412.

The method described above differs from similar ‘push’ methods known in the prior art (such as WAP push) in that the service message that is ‘pushed’ to the UE not only includes service access information but also includes connectivity information that is required before the service access information can be used. For example, for receiving an incoming MMS, the UE typically receives a ‘push’ message indicating the location of an incoming MMS message. This ‘push’ message does not indicate to the UE how to establish connectivity to the packet data network that provides access to MMS services, and thus, to its MMS mailbox. The UE therefore needs to be provisioned with this type of connectivity information. This is acceptable for data services provided by the home network by it is not efficient for local services provided by visited networks or for accessing WiFi hotspots or local IP networks with LIPA due to the vast amount of provisioning information required. With the method described above, the service message that is pushed to the UE includes both connectivity and service access information and, thus, the UE does not need to be pre-provisioned with any type of connectivity information.

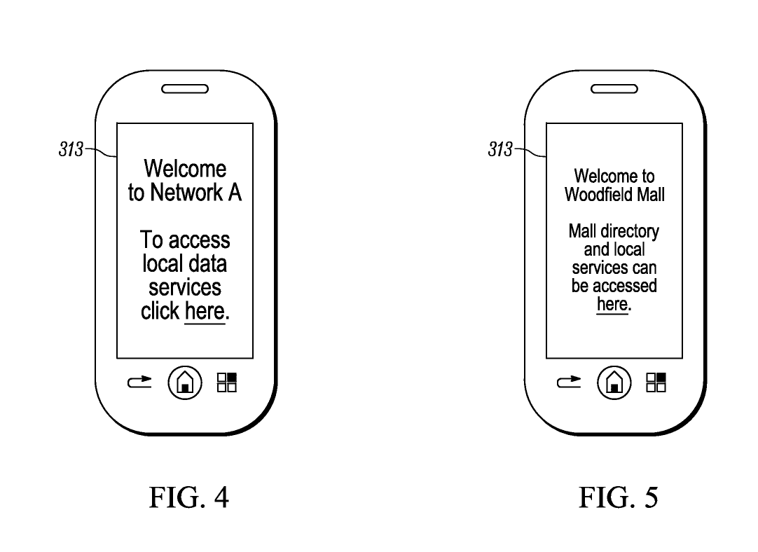

FIGS. 4-7 each show an example display 313 of the UE 122 with examples of messages that may be presented to the user to indicate that a service in a second domain is available in different use scenarios in accordance with the present disclosure.

Referring firstly to FIG. 4, which shows an example of a message that may be displayed on the display 313 in the situation when the UE 122 roams into a new area covered by visited communication network A of network operator A. The UE 122 attaches to the visited communication network A of network operator A and the UE 122 receives a service message as an SMS message. The services message includes connectivity information and service access information in the form of a ‘decorated’ URL such as:

http://apn?roamers.localservices?user:12345@visitors-portal.example.com

In response to receipt of the service message, a welcome message is displayed on the display 313 as shown in FIG. 4. The displayed message includes ‘To access local data services click here’. The word ‘here’ is a link that points to the ‘decorated’ URL shown above. If the user wants to access the local data service, the user selects the link (e.g. by clicking on the word ‘here’). In response to the user selecting the link, the processing unit 302 of the UE 122 detects by means of, for example, a modified HTTP stack that the ‘decorated’ URL includes embedded connectivity information, such as an APN and credentials. When detected, a connection to the identified APN is established by establishing a new PDP context/PDN connection to the embedded APN. Then the ‘stripped’ URL ‘http://visitors-portal.example.com’ is requested in a service request message sent over the established PDP context/PDN connection.

FIG. 5 shows an example of a message that may be displayed on the display 313 in the situation when the UE 122 enters a coverage area of a CSG cell (e.g. cell 104 of FIG. 1) that supports LIPA services. When the network 101 or UE 122 detects that the UE 122 has entered cell 104, the UE 122 receives a service message and a simple alert message is displayed on the display 313 as shown in FIG. 5. The service message may include the simple alert message or the simple alert message may be stored in memory 318 and retrieved by the processing unit 302 in response to the UE 122 receiving the service message. In the latter case, the UE could be pre-provisioned with one alert message per public CSG id. Once the UE enters a CSG, the associated alert messages are retrieved and displayed.

The service message includes connectivity information and service access information in the form of a ‘decorated’ URL such as:

http://apn?lipa.airport?guest:sessami@airport-guide.example.com

The displayed message includes the word ‘here’ which is a link. If the user wants to access the local services, the user selects the link (e.g. by clicking on the word ‘here’). In response to the user selecting the link, the processing unit 302 of the UE 122 detects by means of, for example, a modified HTTP stack that the ‘decorated’ URL includes embedded APN information. When detected, a connection to the identified APN is established by establishing a new PDP context to the embedded APN. Then the ‘stripped’ URL ‘http://airport-guide.example.com’ is requested in a service request message sent over the established PDP context.

An operator can deploy many different LIPA APNs e.g. one for Woodfield mall, one for O'Hare airport etc. By providing connectivity information with the service message on entering the coverage area of cell 104, the present disclosure allows for LIPA APNs to be dynamically provisioned but avoids the problems that may arise having many different LIPA APNs e.g. the need to provision the UE with the many different LIPA APNs and the difficulty of the UE knowing which one is applicable in each CSG cell.

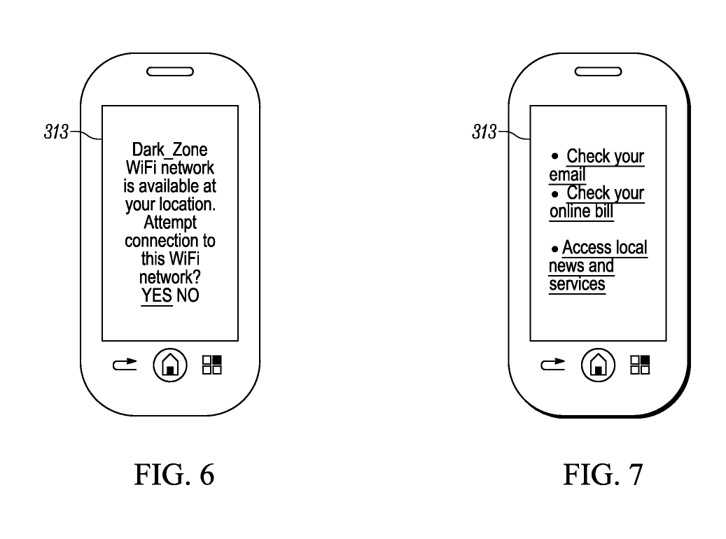

FIG. 6 shows an example of a message that may be displayed on the display 313 in the situation when the UE 122 enters a location near a WiFi hotspot. When the network 101 or UE 122 detects that the UE 122 is near a WiFi hotspot, the UE 122 receives a service message and a simple alert message is displayed on the display 313 as shown in FIG. 6. The service message may include the simple alert message or the simple alert message may be stored in memory 318 and retrieved by the processing unit 302 in response to the UE 122 receiving the service message. The service message includes connectivity and service access information in the form of a ‘decorated’ URL such as the following:

http://wifi?dark_zone?wpa2?none:long_preshared_key@wifi_portal.example.com

SSID=dark_zone, Security=WPA2, Username=none,

Password=long_preshared_key

Stripped URL=http://wifi_portal.example.com

The displayed message includes the word ‘YES’ which is a link. If the user wants to access the local services, the user selects the link (e.g. by clicking on the word ‘YES’). In response to the user selecting the link, the processing unit 302 of the UE 122 detects by means of, for example, a modified HTTP stack that the ‘decorated’ URL includes embedded WiFi information. When detected, a new WiFi profile is created and stored and a connection to the WiFi hotspot is established. Then the ‘stripped’ URL ‘http://wifi_portal.example.com’ is requested in a service request message sent over the established WiFi connection. Thus, the WiFi can be dynamically provisioned and connected to without any user intervention or manual configuration.

FIG. 7 shows an example of a message that may be displayed on the display 313 in the situation when the UE 122 roams into a new area covered by a visited communication network A of network operator A. The UE 122 attaches to the visited communication network A of network operator A and accesses HTTP-based services in its home network B as normal by establishing connectivity to a well-known APN that is pre-configured in the UE. When the user accesses an HTML page e.g. by visiting its home WEB portal, the HTML page may include one or more ‘decorated’ URLs that include connectivity and service access information for IP services provided by the visited network A. In this case, the service message received by the UE is the HTML page retrieved from its home WEB portal. The service message includes connectivity information and service access information in the form of a ‘decorated’ URL such as the example given above:

http://apn?roamers.localservices?user:12345@video.example.com

In response to receipt of the service message, a message is displayed on the display 313. The displayed message includes links for different services. If the user wants to access a service, the user selects the link (e.g. by clicking on the link) for that service. In response to the user selecting a link, the processing unit 302 of the UE 122 detects by means of, for example, a modified HTTP stack that the ‘decorated’ URL associated with the selected link includes embedded APN information. When detected, a connection to the identified APN is established by establishing a new PDP context/PDN connection to the embedded APN. Then the ‘stripped’ URL ‘http://video.example.com’ is requested in a service request message sent over the established PDP context/PDN connection. In this embodiment, the ‘decorated’ URL is embedded in an HTML page retrieved from the user's home WEB portal.

In summary, when a ‘new’ domain is available to a UE, the network sends a service message to the UE and in response, the UE uses connectivity information provided to the UE to establish a connection to the ‘new’ domain and uses the service access information to access a service(s) once a connection is established.

Thus, the present disclosure enables an UE to access many different networks and services in an area in which it is located simply and easily by means of the connectivity information and service access information without the need for dynamic provisioning arrangements with high system overheads.

In an example arrangement, the service message is in the form of a normal URL that conforms to RFC 1738 with additional information including connectivity parameters to enable the UE to establish a connection to the ‘new’ domain for accessing service(s) via the ‘new’ domain and service access information.

It is noted that the term ‘cell’ as used herein is not intended to limit the disclosure to a cellular communication system but should be interpreted broadly as meaning a communication area served by one or more base stations such that a communication device located anywhere in the communication area or cell may communicate with at least one of the one or more of the base stations.

In the foregoing specification, the invention has been described with reference to specific examples of embodiments of the invention. It will, however, be evident that various modifications and changes may be made therein without departing from the broader scope of the invention as set forth in the appended claims.

Some of the above embodiments, as applicable, may be implemented using a variety of different processing systems. For example, the Figures and the discussion thereof describe an exemplary architecture and method which is presented merely to provide a useful reference in discussing various aspects of the disclosure. Of course, the description of the architecture and method has been simplified for purposes of discussion, and it is just one of many different types of appropriate architectures and methods that may be used in accordance with the disclosure. Those skilled in the art will recognize that the boundaries between program elements are merely illustrative and that alternative embodiments may merge elements or impose an alternate decomposition of functionality upon various elements.

1. A method for enabling a wireless communication device, connected to a first domain of a wireless communication network, to access a service in a second domain, the method comprising:
receiving at the wireless communication device a service message from the first domain indicating that a service in the second domain is available and including connectivity information for indicating how a connection to the second domain can be established and service access information for indicating how the service can be accessed after establishing a connection to the second domain;
requesting by a user of the wireless communication device access to the service in the second domain;
in response to requesting access, establishing a connection to the second domain using the received connectivity information; and
accessing the service in the second domain using the received service access information.

2. The method of claim 1, further comprising in response to receiving the service message, indicating to the user that connection to the service in the second domain is available.

3. The method of claim 2, wherein indicating includes displaying a message on a display of the wireless communication device indicating connection to the service in the second domain is available, the message including a link associated with the received connectivity information and the service access information, and wherein requesting includes selecting the link by the user.

4. The method of claim 3, further comprising retrieving, in response to the user selecting the link, the connectivity information and the service access information associated with the link for use by the wireless communication device to access the service in the second domain.

5. The method of claim 1, wherein the connectivity information includes connectivity parameters for indicating to the wireless communication device a type of connection and credentials that are required to establish a connection to the second domain.

6. The method of claim 5, further comprising parsing the received connectivity information to obtain the connectivity parameters for use in establishing a connection to the second domain.

7. The method of claim 1, wherein the second domain is a domain of another wireless communication network or is a second domain of the wireless communication network.

8. The method of claim 1, wherein the second domain is an IP network.

9. The method of claim 8, wherein the IP network includes one of a WiFi network, a network accessible over a dialup connection, a packet data network accessible over a packet switched, PS, domain of the wireless communication network, and a local IP network accessible with LIPA.

10. The method of claim 1, further comprising once a connection to the second domain has been established, sending, via the established connection, a service request message to access the service in the second domain, the service request message including the received service access information for accessing the service.

11. A wireless communication device comprising:
a receiver for receiving a service message from a first domain of a wireless communication network when the wireless communication device is connected to the first domain, the service message indicating that a service in a second domain is available and including connectivity information for indicating how a connection to the second domain can be established and service access information for indicating how the service can be accessed after establishing a connection to the second domain; and
a processing unit coupled to the receiver, wherein the processing unit is arranged to, in response to a user of the wireless communication device requesting access to the service in the second domain, establish a connection to the second domain using the received connectivity information and to access the service in the second domain using the received service access information.

12. The wireless communication device of claim 11, wherein the processing unit is arranged to indicate to the user that connection to the service in the second domain is available, in response to receiving the service message.

13. The wireless communication device of claim 12, further comprising a display, wherein the processing unit is further arranged to display a message on the display of the wireless communication device indicating connection to the service in the second domain is available, the message including a link associated with the received connectivity information and the service access information.

14. The wireless communication device of claim 13, wherein in response to the user selecting the link on the display to request access to the service in the second domain, the processing unit is further arranged to retrieve the connectivity information and service access information associated with the link for use by the wireless communication device to access the service in the second domain.

15. The wireless communication device of claim 11, wherein the connectivity information includes connectivity parameters for indicating to the wireless communication device a type of connection and credentials that are required to establish a connection to the second domain.

16. The wireless communication device of claim 11, wherein the processing unit is further arranged to send, once a connection to the second domain has been established, a service request message to access the service to the second domain, the service request message including the received service access information for accessing the service.

17. The wireless communication device of claim 11, wherein the second domain is an IP network.

18. The wireless communication device of claim 17, wherein the IP network includes one of a WiFi network, a network accessible over a dialup connection, a packet data network accessible over a packet switched, PS, domain of the wireless communication network, and a local IP network accessible with LIPA.

19. A communication system comprising:
a first domain of a wireless communication network for providing services to wireless communication devices;
a second domain for providing services to wireless communication devices; and
a wireless communication device comprising:
a receiver for receiving a service message from the first domain when the wireless communication device is connected to the first domain, the service message indicating that a service in the second domain is available and including connectivity information for indicating how a connection to the second domain can be established and service access information for indicating how the service can be accessed after establishing a connection to the second domain; and
a processing unit coupled to the receiver, wherein the processing unit is arranged to, in response to a user of the wireless communication device requesting access to the service in the second domain, establish a connection to the second domain using the received connectivity information and to access the service in the second domain using the received service access information.
